(19) United States
(12) Patent Application Publication
(10) Pub. No.: US 2005/0157591 A1
(43) Pub. Date: Jul. 21, 2005

(54) Underwater Sonic Child Locator

(75) Inventors: Christine Frances Cheek, Bellaire, TX (US); William Lee Cheek, Bellaire, TX (US)

Correspondence Address: CHRISTINE WILLIAM CHEEK, 4337 VALERIE, BELLAIRE, TX, 77401, US

(73) Assignees: Mrs. Christine Frances Cheek, Bellaire, TX (US); Mr. William Lee Cheek, Bellaire, TX (US)

(21) Appl. No.: 10/707,844

(22) Filed: Jan. 16, 2004

(51) Int. Cl. H04R 1/00

(52) U.S. Cl. 367/142

(57) ABSTRACT

The device would be small enough to be attached to the child's wrist or ankle via a Velcro strap or some other suitable waterproof material. The actual device would be comprised of a water sealed box (similar to an oversized wrist watch) measuring 1.5 in. by 2.5 in. (water proof up to 50 ft. of depth) with a pulsating sound device (a piezo-electric transducer with a 1 in. diameter ceramic element encapsulated in polyurethane and capable of emitting an audible sonic pulse) that would travel underwater for at least 50 ft. The device would have a water-proof rubber encapsulated on/off switch and frequency switch incorporated on either the side of the water sealed box. Additional Specifications for the Sonic Child Locater are as follows: Operating Frequency: 2,000 or 4,000 Hz., switchable.

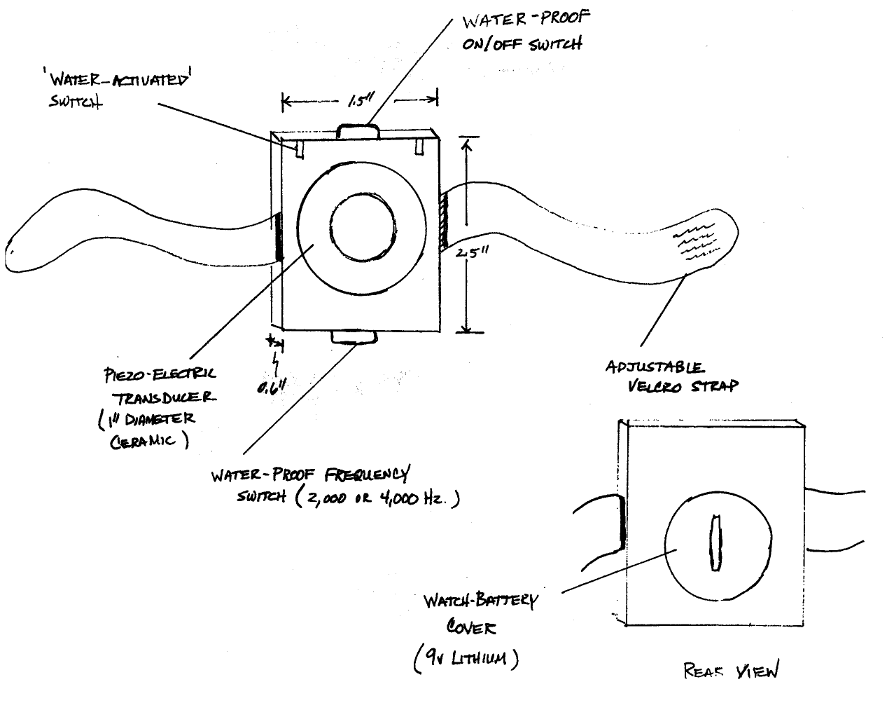

### DETAILED DESCRIPTION

The idea was conceived when spending Jul. 4, 2003 at our Lake house on Lake Livingston Texas. Lake Livingston is a murky, brown, mud bottom lake, with little to no visibility. On Jul. 4^{th} a 5-year-old boy drowned in the lake. The information we learned about the incident was that when a large storm came in early afternoon July 4^{th} the young boy was in the water. He apparently swallowed some water and was unable to keep above water. Although his parents were close by the child did not make a sound as he slipped into the murky lake. When the parents looked back at the lake they had no idea where he was but knew he must be underwater. Because of the non-existent visibility into the water they were unable to locate where he was in the water. By the time he was found it was too late. In thinking about this tragic accident we were talking and I told my husband that someone at work had also told me about a story where someone she knew lost a child at their farm in a man made lake that was also murky. And although the 3-year-old child was viewed slipping into the water they could not find her once she was submerged. I realized at that point that there should be a way for adults to locate children once submerged under water when the water is not clear enough to see into as it is in a pool. However the device could not encumber the child from playing freely in or out of the water.

1. The purpose of the underwater sonic child locator is to be able to enter the water and audibly locate a child who has fallen into or is already swimming but disappears from view in murky low visibility waters. Once in the water the adult could put their head underwater and locate the child by listening for the sonic locator device attached to the child's arm.

2. The advantages of this device are; it is small so it will not encumber the child's play in or out of the water, it allows for the child to go underwater and above water freely, it is inexpensive to manufacture, it only requires minimal battery power, it is pulsating whether in or out of the water so you always know when it is actively working, the pulsating sonic sound would be at such a frequency that it would barely be heard out of the water but readily obvious once under the water.

3. Possible novel features:
a. Prior inventions are visual aides not sonar
b. Prior invention dealt with child outside water and falling in but not actively playing in water.

4. c. Prior invention encumbered the child's play in and out of water.

5. Other devices have been invented that may have underwater sound as a component but no devices include only the sound variable to bring down the cost and the use of these device is not geared towards children.
